(19) United States
(12) Patent Application Publication
(10) Pub. No.: US 2018/0321808 A1
(43) Pub. Date: Nov. 8, 2018

(54) DISPLAY DEVICE

(71) Applicant: SONY CORPORATION, Tokyo (JP)

(72) Inventors: Kazuhiro KITA, Tokyo (JP); Taku INOUE, Kanagawa (JP)

(73) Assignee: SONY CORPORATION, Tokyo (JP)

(21) Appl. No.: 15/781,187

(22) PCT Filed: Oct. 4, 2016
(86) PCT No.: PCT/JP2016/079546

§ 371 Date: Jun. 4, 2018

(30) Foreign Application Priority Data
Jan. 7, 2016 (JP) 2016-001653

(51) Int. Cl. G06F 3/0484; G09G 5/00; H04N 5/74; G03B 21/54

(52) U.S. Cl. CPC G06F 3/0484; G03B 21/54; H04N 5/74; G09G 5/00

(57) ABSTRACT

To propose a display device that can make a presenter timely aware of an elapsed time of a presentation.

A display device including: a timing unit configured to time an elapsed time from a starting time point; a display control unit configured to control a display of a displayed image and an information image including a display related to the elapsed time; and a time setting unit configured to set a presentation time. The display control unit exerts control such that the display of the information image is displayed over the presentation time, and changes a mode of the information image whenever an elapsed time timed by the timing unit reaches a set time.

### TECHNICAL FIELD

The present disclosure relates to a display device.

### BACKGROUND ART

Conventionally, in the case where a presentation is made in a meeting or announcement, a display device such as a projector is used for displaying images on a screen. A presenter who makes a presentation in a meeting or announcement often makes the presentation worrying about the remaining time of the presentation. In this respect, Patent Literatures indicated below disclose display devices that present a display related to the presentation time.

Patent Literature 1 discloses a display device that changes the background of an image or the like projected at a set time. In addition, Patent Literature 2 discloses a display device that changes the size of a message image in accordance with a difference between a set time and an elapsed time.

### CITATION LIST

### Patent Literature

Patent Literature 1: JP 2004-294743A

Patent Literature 2: JP 2015-184649A

### DISCLOSURE OF INVENTION

### Technical Problem

However, in the above-described display devices, the background of an image is changed or a message is displayed when the end time of the presentation approaches. Even if the background is changed or a message is displayed suddenly in this manner when the end time approaches, it is difficult for a presenter to adjust the presentation time.

Therefore, the present disclosure proposes a display device being novel and improved that can make a presenter timely aware of an elapsed time of a presentation.

### Solution to Problem

According to the present disclosure, there is provided a display device including: a timing unit configured to time an elapsed time from a starting time point; a display control unit configured to control a display of a displayed image and an information image including a display related to the elapsed time; and a time setting unit configured to set a presentation time. The display control unit exerts control such that the display of the information image is displayed over the presentation time, and changes a mode of the information image whenever an elapsed time timed by the timing unit reaches a set time.

### Advantageous Effects of Invention

According to the present disclosure as described above, it is possible to make a presenter timely aware of an elapsed time of a presentation.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram showing an example of connection between a projector according to a first embodiment of the present disclosure and a notebook personal computer which is an external device.

FIG. 2 is a block diagram showing an example of a configuration of the projector according to the embodiment.

FIG. 3 is a hierarchical chart showing an example of a hierarchy of setting of the projector according to the embodiment.

FIG. 4A is a diagram showing an example of a setting screen of the projector according to the embodiment.

FIG. 4B is a diagram showing an example of a setting screen of the projector according to the embodiment.

FIG. 5 is a diagram showing an example of a setting screen for setting an informing time of the projector according to the embodiment.

FIG. 6 is a diagram showing an example of a displayed image on the projector according to the embodiment.

FIG. 7 is a diagram showing an example of a mode in which an information image is displayed enlargedly on the projector according to the embodiment.

FIG. 8 is a flowchart showing an example of an operation of the projector according to the embodiment.

FIG. 9 is a diagram showing a modification of a display mode of an information image on the projector according to the embodiment.

FIG. 10 is a diagram showing a modification of a display mode of an information image on the projector according to the embodiment.

FIG. 11 is a diagram showing a modification of a display mode of an information image on the projector according to the embodiment.

FIG. 12 is a diagram showing a modification of a display mode of an information image on the projector according to the embodiment.

FIG. 13 is a diagram showing a modification of a setting screen for setting an informing time on the projector according to the embodiment.

FIG. 14 is a diagram showing an example of a setting screen for setting an informing time on a projector according to a second embodiment.

FIG. 15 is a diagram showing an example of a setting screen for setting an informing page on a projector according to a third embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. First embodiment

1-1. Connection example and configuration example of projector

1-2. Hierarchical structure of setting of projector

1-3. Method of manipulating setting screen of projector

1-4. Method of manipulating timer setting screen

1-5. Example of timer operation

1-6. Modification of timer operation

1-7. Conclusion of first embodiment

2. Second embodiment

3. Third embodiment

4. Supplement

### 1. First Embodiment

### <1-1. Connection Example and Configuration Example of Projector>

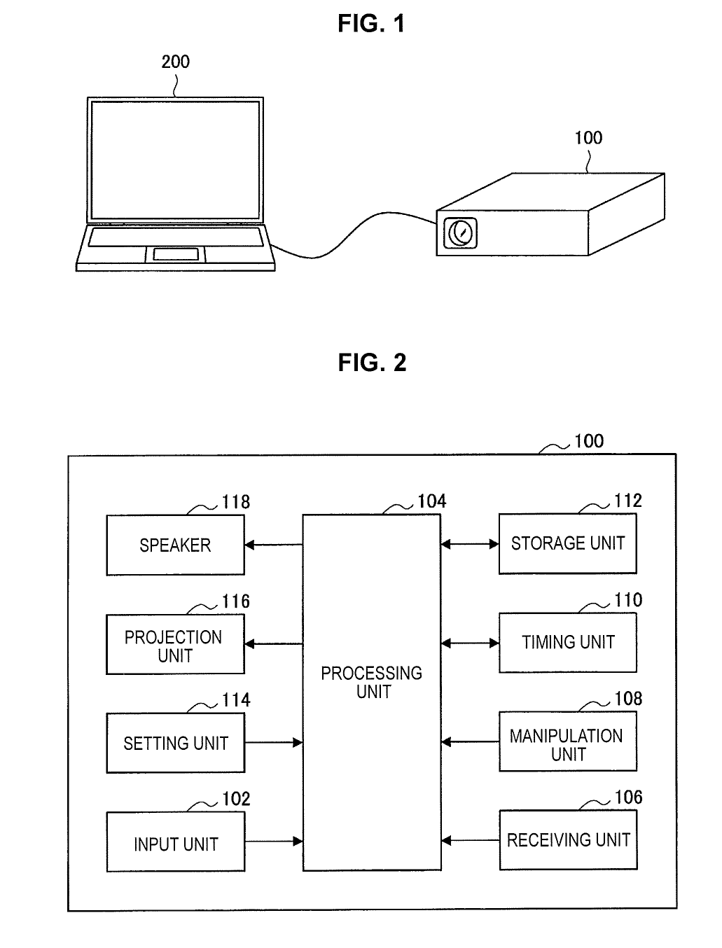

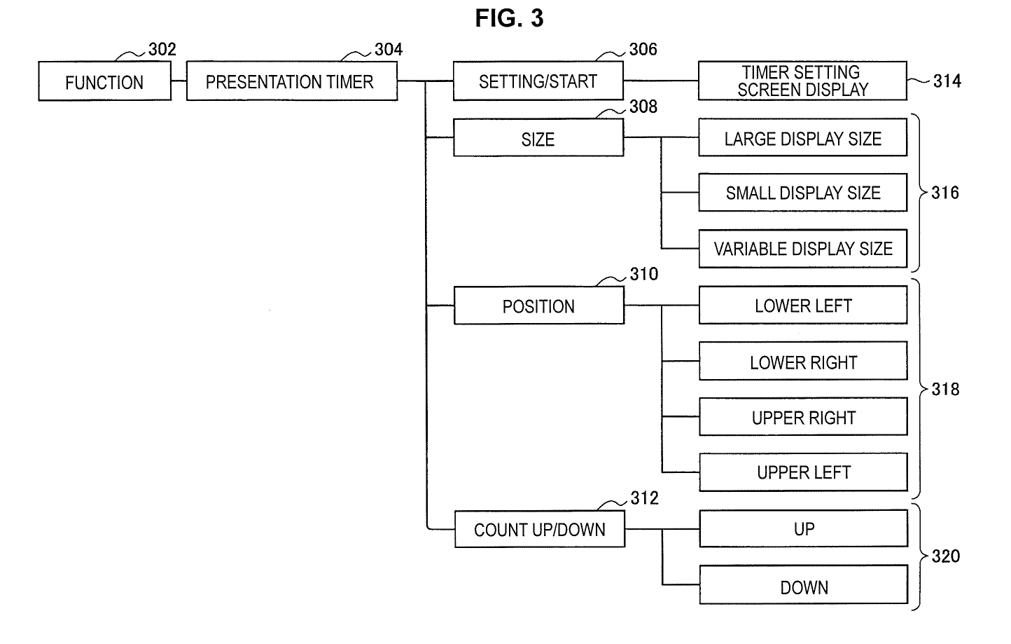

First, with reference to FIG. 1 and FIG. 2, a connection example and configuration example of a projector 100 which is an example of a display device according to a first embodiment of the present disclosure will be described. FIG. 1 is a diagram illustrating an example of connection between the projector 100 of the present embodiment and an external device 200.

The external device 200 stores presentation material having a plurality of pages. A manipulator can turn pages of the presentation material forward and backward by manipulating the external device 200. In addition, the manipulator can make a switch to a mode of outputting the presentation material to an external display device by manipulating the external device 200. In addition, the projector 100 is a device that receives an image output from the external device 200 through a manipulation by the manipulator or the like, and projects the received image on a screen or the like.

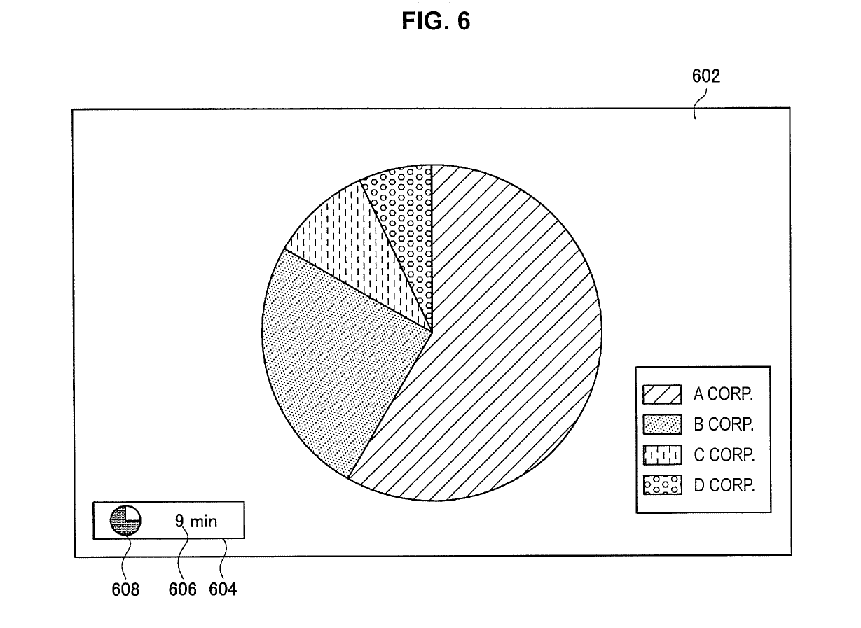

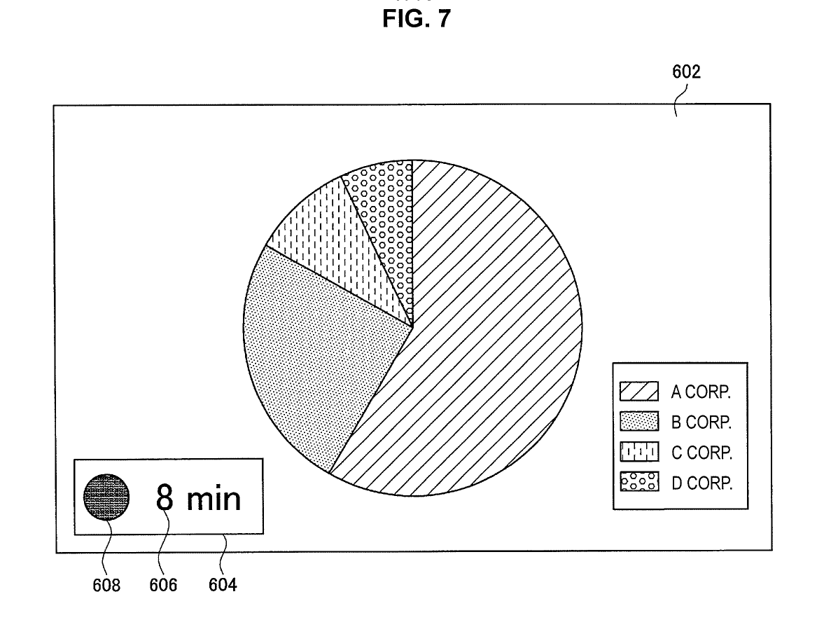

Note that the projector 100 of the present disclosure has a function of a presentation timer that changes the display mode of an information image 604 including a time-related display a plurality of times while a presenter makes a presentation, as will be described later using FIG. 6 and FIG. 7. This allows the presenter who makes a presentation to timely become aware of the elapsed time.

Note that the display device according to the present disclosure is not limited to the projector 100, but any display device that can display an image or video is included in the scope of the present disclosure. For example, the display device may be a display to be used in a meeting, announcement, or the like. In addition, a general-purpose personal computer is also included in the scope of the present disclosure as long as it is a device that performs the operation in accordance with the present disclosure. In addition, a notebook personal computer is shown in FIG. 1 as the external device 200. Note that the scope of the present disclosure is not limited to this, but any device that outputs an image signal or image data is included in the scope of the present disclosure. For example, a device such as a Blu-ray Disc player that outputs a video signal to another device is included in the scope of the present disclosure.

FIG. 2 is a diagram showing a configuration example of the projector 100 of the present embodiment. The projector 100 of the present embodiment includes an input unit 102 that receives a signal or data from the external device 200, a processing unit 104, a receiving unit 106 that receives a manipulation signal from a remote controller or the like, a manipulation unit 108, a timing unit 110, a storage unit 112, a setting unit 114, a projection unit 116, and a speaker 118.

Note that the processing unit 104 is a component that processes image data, and is an example of a display control unit. In addition, the setting unit 114 is a component that performs setting in relation to the operation of the projector 100, and is an example of a time setting unit. In addition, the input unit 102 is a component that acquires an image from the external device 200, and is an example of an image acquisition unit. In FIG. 1, the processing unit 104, the timing unit 110, the storage unit 112, and the setting unit 114 are shown as separate components. However, these members may be one member, and their configuration is not limited as long as the configuration is capable of performing the operation of the present embodiment.

Describing each component in more detail, the input unit 102 may be a high-definition multimedia interface (HDMI), for example. The HDMI (registered trademark) transmits a digital signal in the transition minimized differential signaling (TMDS) system, and transmits an apparatus control signal by consumer electronics control (CEC). In addition, the input unit 102 may be a video graphics array (VGA) terminal, or may be a universal serial bus (USB).

The manipulation unit 108 is installed on the top surface of the body of the projector 100 or the like. In addition, the manipulation unit 108 may include a button for moving a cursor or the like in the vertical and horizontal directions. In addition, a menu button for causing a menu screen to be displayed, a correction button for correcting a projected image, and the like may be provided.

The projection unit 116 has a light source such as a mercury lamp, laser diode, or the like, and a projector lens. In addition, in the case of a transmissive liquid crystal system, the projection unit 116 may be configured to cause rays of respective colors of RGB emitted from the light source to pass through a liquid crystal panel and recombine the rays by a prism or the like to project a projected image.

The setting unit 114 sets a presentation time during which the processing unit 104 performs the operation of the presentation timer, and in addition, sets a setting time and the like which will be described below. In addition, the timing unit 110 times an elapsed time from the start of the operation of the presentation timer. In addition, a format related to the above-described information image 604, or a format related to the setting screen, or a hierarchical structure of setting items which will be described later, and the like are stored in the storage unit 112. In addition, information set by a manipulator, such as the presentation time and set time, is also stored in the storage unit 112.

The processing unit 104 acquires image data output by the external device 200 from the input unit 102. Next, the processing unit 104 performs processing so as to display the information image 604 together with the image acquired from the external device 200. In addition, the processing unit 104 performs processing so as to change the display mode of the information image 604 on the basis of the elapsed time timed by the timing unit 110 and the set time.

### <1-2. Hierarchical Structure of Setting of Projector>

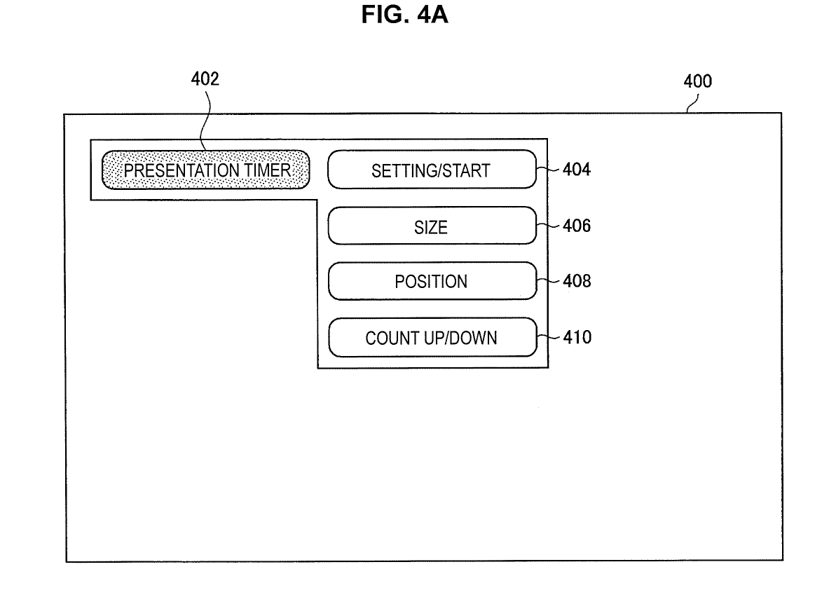

The configuration of the projector 100 of the present disclosure has been described above with reference to FIG. 1 and FIG. 2, and setting items of the projector 100 will be described below. FIG. 3 is a diagram showing a hierarchical structure related to the setting items of the projector 100 of the present embodiment, and the setting items shown in FIG. 3 are stored in the storage unit 112 of the projector 100 of the present embodiment. The item at the highest level of settings related to the operation of the present embodiment is a function item 302, and this function item 302 includes a plurality of settings related to the functions of the projector 100. The item at the next level of the function item 302 includes a presentation timer item 304, and this is a setting item for performing setting related to a mode of displaying the information image 604 which will be described later.

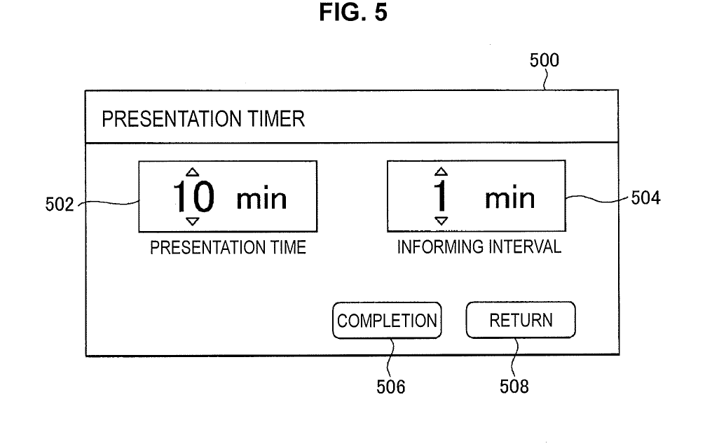

The third level includes setting items of a setting/start item 306, a size item 308, a position item 310, and a count up/down item 312. The setting/start item 306 includes a timer setting screen display item 314 for displaying a setting screen of a presentation timer which will be described later in FIG. 5. In addition, the size item 308 is a setting item for setting the size in which the information image 604 is displayed, and, for example, the display size of the information image 604 may include three setting items 316 of large, small, and variable. Here, the setting items of large and small display sizes are setting items for displaying the information image 604 in fixed predetermined sizes. In addition, the setting item of variable display size is set in the case where the display mode of the information image 604 is changed which will be described later in detail.

Next, the position item 310 is a setting item for setting the position at which the information image 604 is displayed, and, for example, the display position of the information image 604 is selected from among setting items 318 of lower left, lower right, upper right, and upper left. In addition, the count up/down item 312 includes a count up/down setting item 320 for setting whether a time-related display included in the information image 604 is to be displayed in a count-up manner or to be displayed in a count-down manner.

### <1-3. Method of Manipulating Setting Screen of Projector>

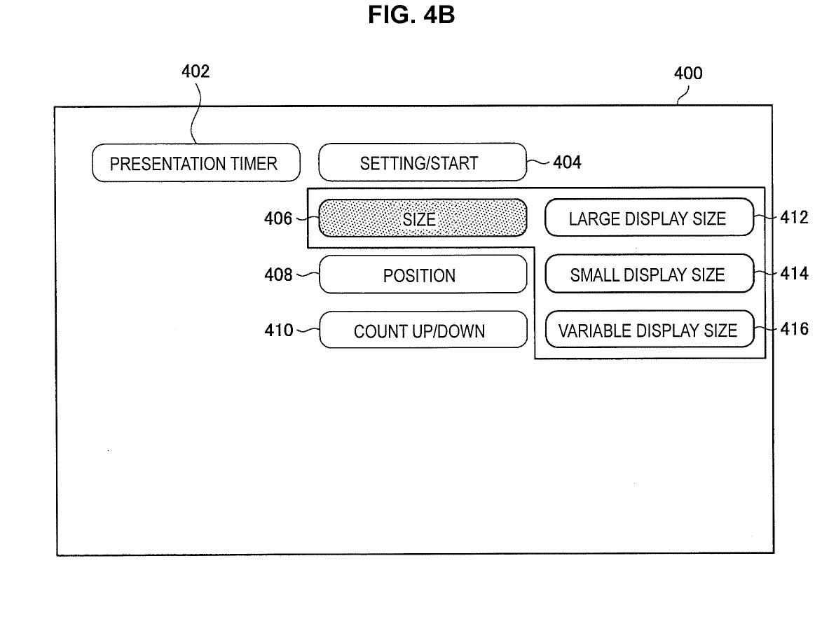

FIG. 3 shows the hierarchical structure of the setting items. Hereinafter, a setting screen and a manipulating method on the setting screen will be described. FIG. 4A and FIG. 4B show an item setting screen 400 of the projector 100 of the present embodiment. The processing unit 104 reads out information related to a setting item from the storage unit 112, and performs processing so as to display the setting screen 400. When the manipulator manipulates a menu button of the manipulation unit 108 of the body of the projector 100 or a remote controller, the projector 100 displays the item setting screen 400. When the manipulator manipulates an up/down button of the manipulation unit 108 or a remote controller to place a cursor or the like on a presentation timer icon 402 of the item setting screen 400, the projector 100 displays the item setting screen 400 as shown in FIG. 4A. In FIG. 4A, icons corresponding to the setting/start item 306, the size item 308, the position item 310, and the count up/down item 312 described using FIG. 3 included at the levels below the presentation timer item 304 are displayed. Specifically, a setting/start icon 404, a size icon 406, a position icon 408, and a count up/down icon 410 are displayed on the item setting screen 400.

Next, by manipulating up, down, left, and right buttons of the manipulation unit 108 or the remote controller, the manipulator moves the cursor or the like to place the cursor on an item that he/she wants to set, and selects the setting item. FIG. 4B is a diagram illustrating the item setting screen 400 displayed when the manipulator selects the size icon 406. In FIG. 4B, icons corresponding to items included at levels below the size item 308 are displayed. Specifically, respective icons of a large display size icon 412, a small display size icon 414, and a variable display size icon 416 are displayed. Next, when the manipulator manipulates the up, down, left, and right buttons of the manipulation unit 108 or the remote controller to place the cursor or the like on the icon of the size that he/she wants to set and selects the icon, the size of the information image 604 is set.

### <1-4. Method of Manipulating Timer Setting Screen>

In FIG. 4A and FIG. 4B, the setting screen and manipulation method for setting the size, position, and the like in which the information image 604 is displayed are shown. Next, in FIG. 5, a timer setting screen 500 for setting a presentation time during which the presentation timer operates and a set time at which the display mode of the information image 604 is changed as well as a manipulation method of the timer setting screen 500 are shown. The timer setting screen 500 shown in FIG. 5 is displayed when the manipulator sequentially selects items in the item setting screen 400 shown in FIG. 4A and FIG. 4B. Specifically, when the manipulator selects the presentation timer icon 402, selects the setting/start icon 404, and selects a setting screen display icon included in the setting/start icon 404, the timer setting screen 500 shown in FIG. 5 is displayed.

The format of the timer setting screen 500 is stored in the storage unit 112, and the processing unit 104 reads out the format from the storage unit 112 to display the timer setting screen 500. The processing unit 104 performs processing so as to change a number, cursor, or the like within the timer setting screen 500 on the basis of the format read out when the manipulator manipulates the timer setting screen 500.

A plurality of set times at which the display mode of the information image 604 is changed are set using the timer setting screen 500. The set time is set on the basis of an informing interval set in the timer setting screen 500. That is, when the informing interval is set at one minute, the set time is set every one minute after the start of the presentation timer. Describing more specifically, the set time is set at a time point when one minute elapses after the start of the presentation timer, and is also set at a time point when two minutes elapse after the start of the presentation timer, and is set similarly thereafter. Note that it is understood that the set time has been set on the basis of the informing interval whatever the configuration as long as the processing unit 104 is configured to change the display mode of the information image 604 on the basis of the informing interval having been set.

The timer setting screen 500 shown in FIG. 5 includes a presentation time setting box 502 to be used for setting the presentation time, and an informing interval setting box 504 to be used for setting the informing interval at which the information image 604 is displayed with the mode changed. In addition, the timer setting screen 500 includes a completion button 506 to be manipulated when completing timer setting and starting the operation of the presentation timer and a return button 508 to be manipulated when cancelling the timer setting and returning to the item setting screen 400 shown in FIG. 4B.

Describing the manipulation method of the timer setting screen 500, the manipulator manipulates the up, down, left, and right buttons of the manipulation unit 108 or the remote controller to move the cursor or the like, and selects each item in the timer setting screen 500. Initially, the manipulator places the cursor on the presentation time setting box 502, and when the cursor is placed on the presentation time setting box 502, the manipulator manipulates the up/down button of the manipulation unit 108 or the remote controller. For example, it may be configured such that, when the manipulator manipulates the up button, the presentation time is incremented by one minute, and in addition, when the manipulator manipulates the down button, the presentation time is decremented by one minute. In addition, it may be configured such that, when the manipulator presses and holds the up/down button for a predetermined time, the presentation time is incremented/decremented by ten minutes or five minutes. By adopting a configuration in which, when the manipulator presses and holds the up/down button in this manner, the presentation time can be incremented/decremented at predetermined intervals, it is possible to set the presentation time more easily.

When the manipulator finishes setting the presentation time, then, the manipulator manipulates the up, down, left, and right buttons to place the cursor on the informing interval setting box 504. When the cursor is placed on the informing interval setting box 504, the manipulator manipulates the up/down button. For example, it may be configured such that, when the manipulator manipulates the up button, the informing interval is incremented by one minute, and in addition, when the manipulator manipulates the down button, the informing interval is decremented by one minute. In addition, it may be configured such that, when the manipulator presses and holds the up/down button for a predetermined time, the informing interval is incremented/decremented by five minutes. By adopting a configuration in which, by pressing and holding the up/down button, the informing interval can be incremented/decremented at predetermined intervals in this manner, it is possible to set the informing interval more easily.

When the manipulator finishes setting the presentation time and the informing interval, the manipulator manipulates the up, down, left, and right buttons to place the cursor on the completion button 506, and selects the completion button 506, so that the operation of the presentation timer is started. Here, when the manipulator wants to change the size or position of the information image 604, the manipulator can return to the item setting screen 400 shown in FIG. 4B by placing the cursor on the return button 508 and selecting the return button 508.

### <1-5. Example of Timer Operation>

Regarding the presentation timer function of the present embodiment, the method of setting the presentation time and the informing interval at which the information image 604 is displayed with the mode changed is shown in FIG. 5. Next, in FIG. 6 and FIG. 7, an example of a timer operation in the function of the presentation timer started after the manipulator selects the completion button 506 in FIG. 5 is shown. Hereinafter, an example of the timer operation in the case where the presentation time is set at ten minutes and the informing interval is set at one minute on the timer setting screen 500 shown in FIG. 5 will be described.

FIG. 6 is an image displayed by the projector 100, and a displayed image 602 is an image input from the external device 200 to the projector 100 via the input unit 102. The processing unit 104 performs processing so as to display the information image 604 and the displayed image 602 together. The format of the information image 604 is stored in the storage unit 112, and the processing unit 104 reads out the format from the storage unit 112 to display the information image 604. The processing unit 104 performs processing so as to change a number, graph, or the like in the information image 604 on the basis of the format having been read out. In FIG. 6, an image when fifteen seconds have elapsed after the start of the operation of the presentation timer is shown. When the operation of the presentation timer is started, the processing unit 104 may perform processing so as to display the displayed image 602 in full screen to be displayed together with the information image 604. In addition, the timing unit 110 starts timing the elapsed time.

In addition, FIG. 6 shows a display mode of the information image 604 in the case where countdown has been selected in setting. In FIG. 6, the processing unit displays the displayed image 602 in full screen across the entire projected image. Note that the method of displaying the display screen 602 is not limited to full screen display. For example, the processing unit 104 may perform processing so as to display the displayed image 602 in a reduced manner such that the displayed image 602 and the information image 604 do not overlap each other. In addition, the processing unit 104 exerts control so as to display the information image 604 while the operation of the presentation timer is performed. Note that, from a viewpoint of making the presenter aware of the lapse of time, it is preferable that the processing unit 104 exerts control so as to display the information image 604 at all times during the presentation time, or the information image 604 may be displayed intermittently.

In addition, the information image 604 includes information related to the elapsed time from the starting time point of the operation of the presentation timer. The information includes a first image related to a first time unit and a second image related to a second time unit which is shorter than the first time unit, and the like. For example, the first image related to the first time unit is a minute-information display part 606 that displays minute-related information as shown in FIG. 6. In addition, the second image related to the second time unit which is shorter than the first time unit is a second-information display part 608 that displays second-related information as shown in FIG. 6. It is configured such that the minute-information display part 606 represents minute-related information by a number, and the second-information display part 608 represents second-related information by a pie chart.

As shown in FIG. 6, the processing unit 104 processes the second-information display part 608 such that a quarter of the pie chart decreases every time fifteen seconds elapse. That is, FIG. 6 shows that nine minutes and forty-five seconds are left for the presentation time.

By displaying the second-related information in a display form such as a pie chart different from a number in this manner, it is possible for the presenter to immediately distinguish between the minute-related information and the second-related information. In addition, by displaying the second-related information in a display form such as a pie chart different from a number, the display space is reduced, and in addition, the elapsed time can be impressed on the presenter more intuitively. Note that the second-information display part 608 may be a display that flashes at predetermined intervals (for example, every one second).

FIG. 6 shows an image after fifteen seconds have elapsed from the start of the operation of the presentation timer, whilst FIG. 7 shows an image after forty-five seconds have elapsed from the state shown in FIG. 6. That is, FIG. 7 is a diagram showing a state in which one minute has elapsed after the start of the operation of the presentation timer. Since the informing interval is set at one minute as described above, the processing unit 104 displays the information image 604 enlargedly in FIG. 7 as compared with the state shown in FIG. 6. In this manner, the processing unit 104 performs processing so as to display the information image 604 enlargedly every one minute. That is, in the case where the presentation time is set at ten minutes and the informing interval is set at one minute, the processing unit 104 performs processing so as to display the information image 604 enlargedly whenever the timing unit 110 times one minute. That is, the processing unit 104 similarly displays the information image 604 enlargedly nine times in total before the end of the operation of the presentation timer.

Note that, as shown in FIG. 7, after the processing unit 104 displays the information image 604 enlargedly, the processing unit 104 keeps the information image 604 in the enlargedly displayed state for a predetermined time. Then, after the lapse of the predetermined time, the processing unit 104 returns the information image 604 to an original size. Note that the predetermined time during which the processing unit 104 displays the information image 604 enlargedly may be approximately five seconds, and the length is not limited.

As described above, the processing unit 104 displays the information image 604 over the presentation time. In addition, the processing unit 104 displays the information image 604 enlargedly at predetermined intervals. Accordingly, the presenter can recognize the lapse of time at any timing, and even if he/she concentrates on an announcement and failing to recognize the elapsed time, the presenter can be made aware of the elapsed time periodically. Thus, the presenter can adjust the progress of the announcement with the remaining time, and can pace himself/herself appropriately. In addition, since the display mode of the information image 604 having been displayed changes, the presenter is informed of the elapsed time without a strange feeling, as compared with the display method in which an image that informs the elapsed time is displayed suddenly.

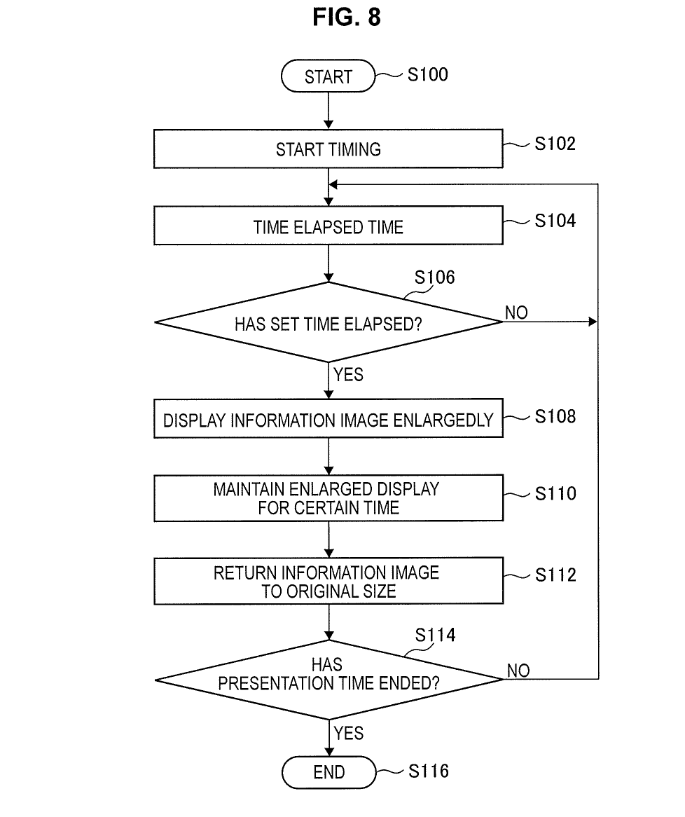

A display example during the timer operation has been described above with reference to FIG. 6 and FIG. 7. Next, FIG. 8 shows a flowchart of the timer operation. In the projector 100 of the present embodiment, the process is started when the manipulator selects the completion button 506 of FIG. 5 in S100. When the process of the timer is started, the timing unit 110 starts timing and times the elapsed time in S102 and S104.

Next, in S106, the processing unit 104 determines whether or not the set time set for changing the display mode of the information image 604 has elapsed in the setting unit 114. In the above-described example, the set time is set on the basis of the informing interval (in the above-described example, one-minute intervals). In the case where the elapsed time timed by the timing unit 110 reaches the set time, the processing unit 104 in S108 performs processing so as to display the information image 604 enlargedly. In S110, the processing unit 104 keeps the information image 604 displayed enlargedly in S108 in the enlargedly displayed state for a certain time (for example, five seconds). Next, in S112, the processing unit 104 performs processing so as to return and display the information image 604 to an original size after displaying the information image 604 enlargedly for the certain time.

In S114, the processing unit 104 determines whether or not the set presentation time (in the above-described example, ten minutes) has elapsed. If the elapsed time has not reached the set presentation time, the process returns to S104, and processing from S104 to S114 is repeated. In S114, when the processing unit 104 determines that the elapsed time has reached the set presentation time, the process transitions to S116, and the process ends.

### <1-6. Modification of Timer Operation>

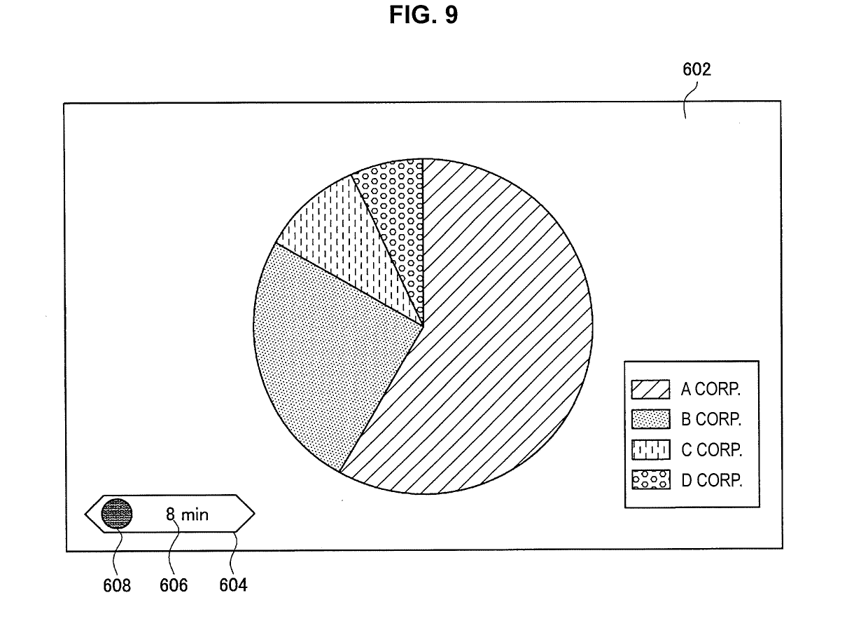

FIG. 6 to FIG. 8 show a mode in which the processing unit 104 displays the information image 604 enlargedly at each set time based on the informing interval having been set. Next, FIG. 9 to FIG. 12 show a mode in which the presenter is informed of the elapsed time in another mode at each set time.

### First Modification

FIG. 9 shows an example in which the processing unit 104 changes the shape of the information image 604, instead of displaying the information image 604 enlargedly in FIG. 7. In FIG. 9, when the elapsed time reaches the set time, the processing unit 104 deforms the shorter sides of the information image 604 having been displayed in a rectangular shape to display the information image 604 with the shape deformed into hexagon. Note that the deformed shape may be any shape, and may be oval, for example, and hexagon is not a limitation.

By configuring in this manner, the space in which the information image 604 is displayed is reduced as compared with the case in which the processing unit 104 displays the information image 604 enlargedly. Therefore, the displayed image 602 and the information image 604 are displayed without overlapping each other.

### Second Modification

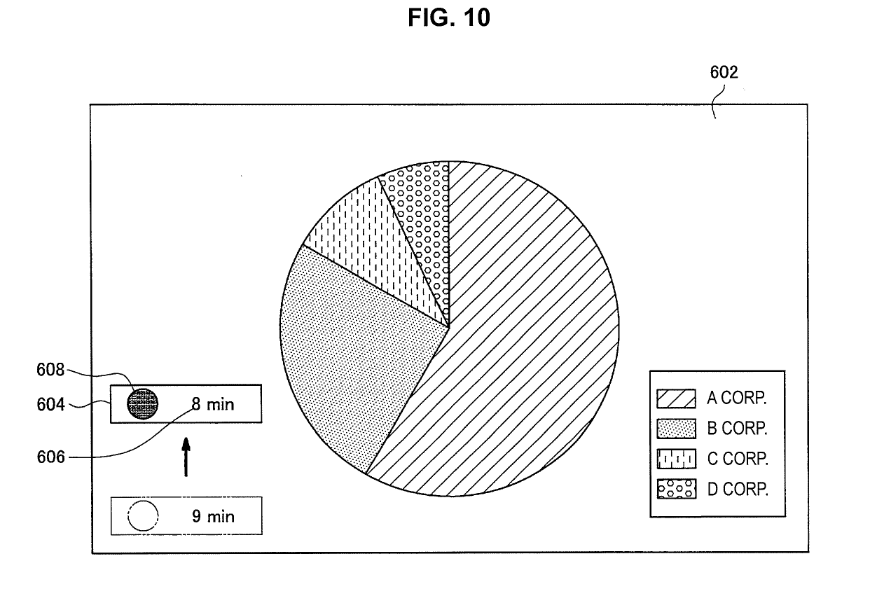

FIG. 10 shows an example in which the processing unit 104 displays the information image 604 with the display position changed, instead of displaying the information image 604 enlargedly in FIG. 7. In FIG. 10, a mode in which, when the elapsed time reaches the set time, the processing unit 104 moves upward the information image 604 having been displayed at lower left is shown. Note that the direction in which the processing unit 104 moves the information image 604 may be any direction, and may be the lateral direction and the diagonal direction, for example, and upward is not a limitation.

When the processing unit 104 moves the position of the information image 604 in this manner, the presenter will track the information image 604 with eyes, so that the presenter can recognize the lapse of time more reliably.

### Third Modification

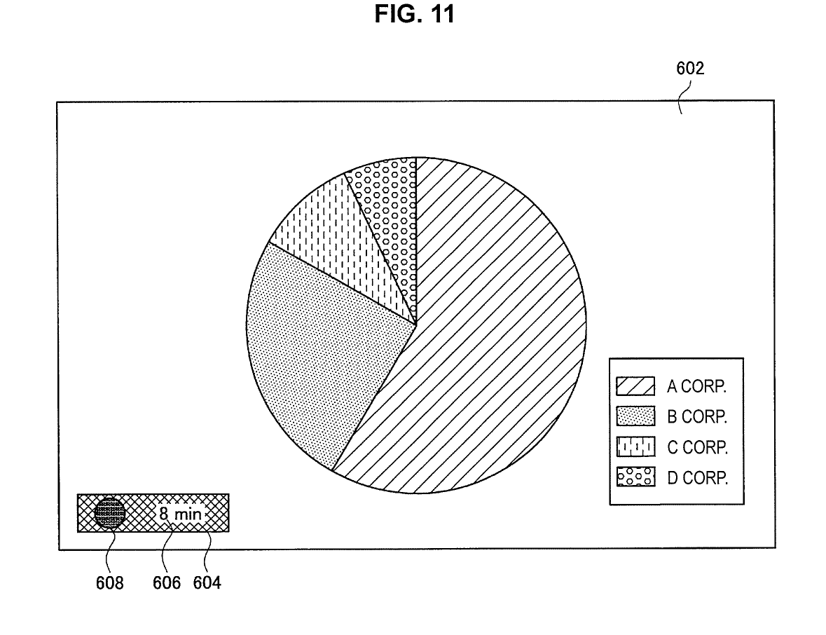

FIG. 11 shows an example in which the processing unit 104 displays the information image 604 with the color changed, instead of displaying the information image 604 enlargedly in FIG. 7. In FIG. 11, a mode in which, when the elapsed time reaches the set time, the processing unit 104 changes the background of the information image 604 from white to another color (for example, red or blue) is shown. Note that the color of the background is not limited to one, but the color to be changed may vary depending on the elapsed time or the remaining time, for example. For example, in the case where the presentation time is set at twenty minutes, and the informing interval is set at five minutes, it may be configured such that the color of the background is changed to blue if the remaining time reaches fifteen minutes, changed to yellow if the remaining time reaches ten minutes, and changed to red if the remaining time reaches five minutes.

When the processing unit 104 changes the color of the information image 604 in this manner, the presenter can recognize the lapse of time. Particularly in the case where the color to be changed varies depending on the remaining time, the presenter can recognize the remaining time easily merely by recognizing the color.

### Fourth Modification

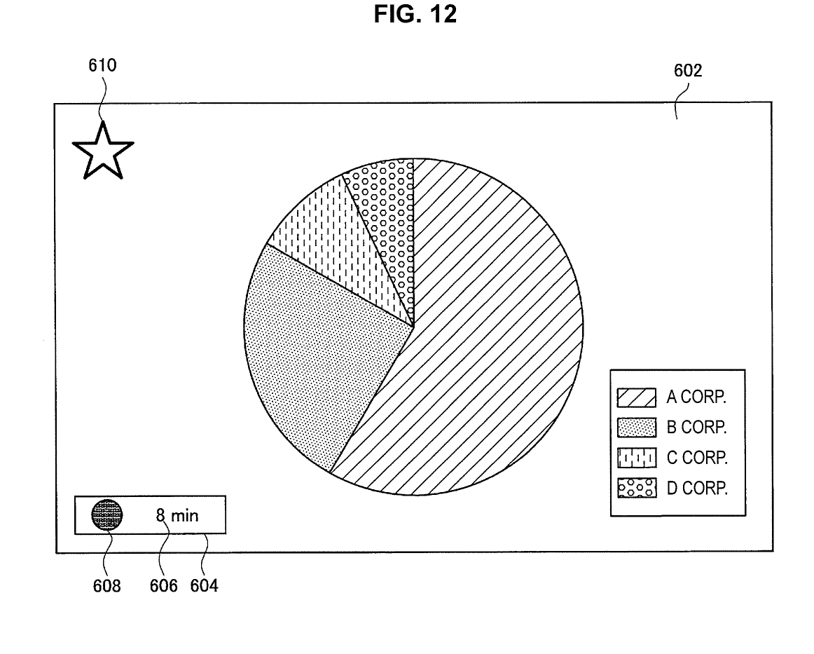

FIG. 12 shows an example in which the processing unit 104 displays another information image 610, instead of displaying the information image 604 enlargedly in FIG. 7. In FIG. 12, a mode in which, when the elapsed time reaches the set time, the processing unit 104 displays the other information image 610 having a star shape in an upper left portion of the displayed image 602 is shown. Note that the shape of the other information image 610 is not limited to the star shape, and in addition, the display position is not limited to upper left. In addition, the other information image 610 may include a message.

### Fifth Modification

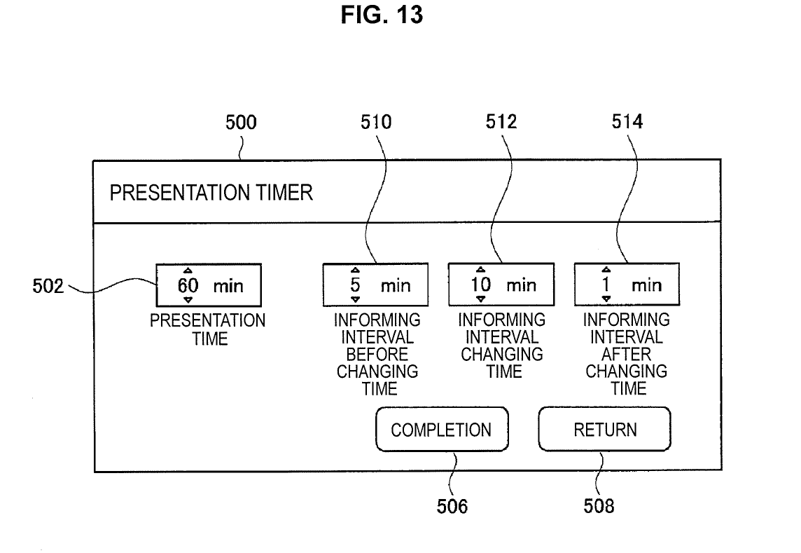

Modes in which the processing unit 104 changes the display mode of the information image 604 at single time intervals have been shown above. Next, in FIG. 13, a modification in which the processing unit 104 changes the display mode of the information image 604 at a first time interval and a second time interval which is shorter than the first time interval will be described. FIG. 13 is a diagram showing the timer setting screen 500 according to the present modification. The timer setting screen 500 shown in FIG. 13 further includes a first informing interval setting box 510 for setting a first informing interval corresponding to the first time interval, an informing interval changing time setting box 512, and a second informing interval setting box 514 for setting a second informing interval corresponding to the second time interval.

The first informing interval setting box 510 is a box to be used for setting the first informing interval at which the processing unit 104 changes the display mode of the information image 604 between the start of the operation of the presentation timer and the informing interval changing time. In addition, the second informing interval setting box 514 is a box to be used for setting the second informing interval at which the processing unit 104 changes the display mode of the information image 604 between the informing interval changing time and the end of the presentation timer. The informing interval changing time setting box 512 is a box to be used for setting the time of switching from the first informing interval to the second informing interval.

As shown in FIG. 13, an example of a timer operation in the case of setting the presentation time at sixty minutes, the first informing interval at five minutes, the informing interval changing time at ten minutes, and the second informing interval at one minute will be described below.

When each item is set as described above, the processing unit 104 changes the display mode of the information image 604 every five minutes after the start of the operation of the presentation timer. When fifty minutes elapses after the presentation is started, that is, when the remaining time of the presentation time reaches ten minutes, the processing unit 104 changes the display mode of the information image 604 every one minute.

In the case where the end time approaches in this manner, the processing unit 104 changes the time interval at which the display mode of the information image 604 changes to a shorter interval. Accordingly, the presenter can obtain more detailed information when the end time of the presentation approaches. In addition, since the presenter can become aware of the elapsed time at shorter intervals, the presenter can change the speed of talking or a page to be described to make both ends of the presentation time meet.

### <1-7. Conclusion of First Embodiment>

As described above, in the present embodiment, by changing the display mode of the information image 604 including the time-related information a plurality of times in the projector 100 to be used when making a presentation, the presenter can become aware of the elapsed time. In addition, by changing the display mode of the information image 604 at predetermined intervals, the presenter can become aware of the elapsed time periodically.

### 2. Second Embodiment

In the first embodiment, an example in which the processing unit 104 changes the display mode of the information image 604 at certain intervals has been described. In the second embodiment, an example in which the processing unit 104 changes the display mode of the information image 604 at any informing time will be described. Note that the informing time is the time at which the processing unit 104 changes the display mode of the information image 604, and is thus an example of a plurality of set times described above.

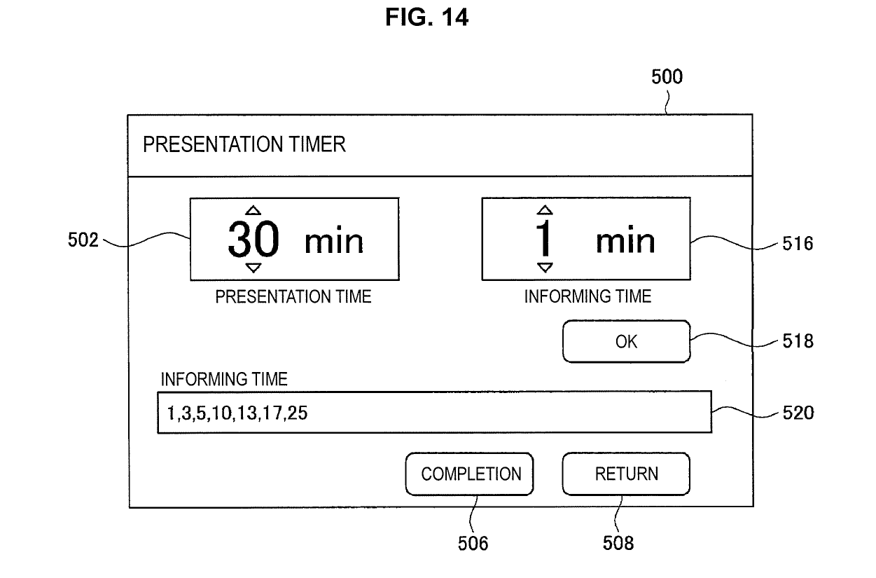

FIG. 14 is a diagram showing the timer setting screen 500 according to the present embodiment. The timer setting screen 500 shown in FIG. 14 further includes an informing time setting box 516, an informing time OK button 518, and an informing time display box 520.

The manipulation method of the timer setting screen 500 shown in FIG. 14 will be described below. The manipulator manipulates the up, down, left, and right buttons of the manipulation unit 108 to place the cursor on the informing time setting box 516. Next, the manipulator increments/decrements the informing time using the up/down button of the manipulation unit 108 to adjust a number in the informing time setting box 516 to the time of which the presenter wants to be informed.

Next, the manipulator places the cursor on the informing time OK button 518 using the up, down, left, and right buttons to determine the informing time. When the manipulator determines the informing time, the informing time determined by the manipulator is displayed in the informing time display box 520.

Specifically describing the above-described manipulation method, when the manipulator adjusts the numeric value to “1 min” in the informing time setting box 516 and determines the informing time, “1” is displayed in the informing time display box 520. The state shown in FIG. 14 is a state in which the manipulator has similarly determined “25”, “17”, “13”, “10”, “5”, and “3” in the informing time setting box 516.

In the case where the setting is performed in this manner, the processing unit 104 changes the display mode of the information image 604 at the time displayed in the informing time display box 520, that is, at any time point set by the manipulator. Since such a configuration allows the display mode of the information image 604 to change at timing of which the presenter wants to be informed, the presenter can grasp the elapsed time at appropriate timing.

### 3. Third Embodiment

In the first and second embodiments, examples in which the processing unit 104 changes the display mode of the information image 604 at a predetermined set time have been described. In the third embodiment, an example in which, in a case where slide material having page numbers is used as data, or the like, the processing unit 104 changes the display mode of the information image 604 on any page will be described.

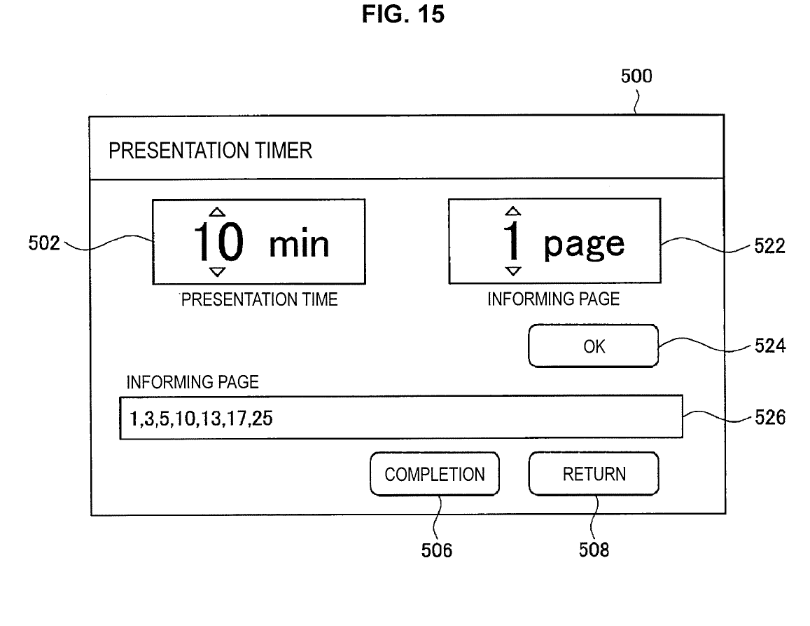

FIG. 15 is a diagram showing the timer setting screen 500 according to the present embodiment. The timer setting screen 500 shown in FIG. 15 further includes an informing page setting box 522, an informing page OK button 524, and an informing page display box 526.

The manipulation method of the timer setting screen 500 shown in FIG. 15 will be described below. The manipulator manipulates the up, down, left, and right buttons of the manipulation unit 108 to place the cursor on the informing page setting box 522. Next, the manipulator increments/decrements the informing page using the up/down button of the manipulation unit 108 to adjust the number in the informing page setting box 522 to a page of which the presenter wants to be informed.

Next, the manipulator places the cursor on the informing page OK button 524 using the up, down, left, and right buttons to determine the informing page. When the manipulator determines the informing page, the informing page determined by the manipulator is displayed in the informing page display box 526.

Specifically describing the above-described manipulation method, when the manipulator adjusts the numeric value to “1 page” in the informing page setting box 522 and determines the informing page, “1” is displayed in the informing page display box 526. The state shown in FIG. 15 is a state in which the manipulator has similarly determined “25”, “17”, “13”, “10”, “5”, and “3” in the informing page setting box 522.

In the case where the setting is performed in this manner, the processing unit 104 changes the display mode of the information image 604 on the pages displayed in the informing page display box 526, that is, any pages set by the manipulator. In the case where the projector 100 is configured in this manner, the processing unit 104 may be configured to acquire information indicating the number of pages of the displayed image 602 from the external device 200 via the input unit 102.

Since such a configuration allows the display mode of the information image 604 to change on pages of which the presenter wants to be informed, the presenter can grasp the elapsed time on appropriate pages. This is useful when grasping how long time is required to which page when the presenter practices making an announcement, for example, and the like.

### <4. Supplement>

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, regarding the change in display mode of the information image 604, enlargement, shape change, position movement, color change, and the like of the information image 604 have been shown in this specification, whilst these are not limitations. In addition, such changes in display mode may be combined. For example, the information image 604 may be enlarged and further may be moved, or the information image 604 may be changed in color and may be enlarged. In addition, in the case where the projector 100 includes the speaker 118, a sound may be made instead of changing the display mode of the information image 604 or in addition to changing the display mode of the information image 604.

In addition, a computer program for causing the processing unit 104 to operate as described above may be provided. In addition, a storage medium having such a program stored thereon may be provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A display device including:
a timing unit configured to time an elapsed time from a starting time point;
a display control unit configured to control a display of a displayed image and an information image including a display related to the elapsed time; and
a time setting unit configured to set a presentation time, in which
the display control unit
   exerts control such that the display of the information image is displayed over the presentation time, and
   changes a mode of the information image whenever an elapsed time timed by the timing unit reaches a set time.
      (2)

The display device according to (1), in which
the set time is set at a certain time interval.
   (3)

The display device according to (1), in which
the set time is set every first time interval before a predetermined time elapses, and is set every second time interval which is shorter than the first time interval after a lapse of the predetermined time.
   (4)

The display device according to any one of (1) to (3), in which
changing, by the display control unit, the mode of the information image includes enlarging the information image.
   (5)

The display device according to any one of (1) to (3), in which
changing, by the display control unit, the mode of the information image includes changing a shape of the information image.
   (6)

The display device according to any one of (1) to (3), in which
changing, by the display control unit, the mode of the information image includes changing a display position of the information image.
   (7)

The display device according to any one of (1) to (3), in which
changing, by the display control unit, the mode of the information image includes changing a color of the information image.
   (8)

The display device according to any one of (1) to (7), in which
the information image includes a first image related to a first time unit and a second image related to a second time unit which is shorter than the first time unit.
   (9)

The display device according to (8), in which
the first image and the second image are different in display form.
   (10)

The display device according to (9), in which
the first image is a number, and the second image is a pie chart.

The display device according to any one of (1) to (10), further including:
an image acquisition unit configured to acquire the displayed image from an external device; and
a projection unit configured to project the display device and the information image.

### REFERENCE SIGNS LIST

100 projector

102 input unit

104 processing unit

106 receiving unit

108 manipulation unit

110 timing unit

112 storage unit

114 setting unit

116 projection unit

118 speaker

200 external device

400 item setting screen

500 timer setting screen

502 presentation time setting box

504 informing interval setting box

510 first informing interval setting box

512 informing interval changing time setting box

514 second informing interval setting box

516 informing time setting box

520 informing time display box

522 informing page setting box

526 informing page display box

602 displayed image

604 information image

606 minute-information display part

608 second-information display part

1. A display device comprising:
a timing unit configured to time an elapsed time from a starting time point;
a display control unit configured to control a display of a displayed image and an information image including a display related to the elapsed time; and
a time setting unit configured to set a presentation time, wherein
the display control unit
exerts control such that the display of the information image is displayed over the presentation time, and
changes a mode of the information image whenever an elapsed time timed by the timing unit reaches a set time.

2. The display device according to claim 1, wherein
the set time is set at a certain time interval.

3. The display device according to claim 1, wherein
the set time is set every first time interval before a predetermined time elapses, and is set every second time interval which is shorter than the first time interval after a lapse of the predetermined time.

4. The display device according to claim 1, wherein
changing, by the display control unit, the mode of the information image includes enlarging the information image.

5. The display device according to claim 1, wherein
changing, by the display control unit, the mode of the information image includes changing a shape of the information image.

6. The display device according to claim 1, wherein
changing, by the display control unit, the mode of the information image includes changing a display position of the information image.

7. The display device according to claim 1, wherein
changing, by the display control unit, the mode of the information image includes changing a color of the information image.

8. The display device according to claim 1, wherein
the information image includes a first image related to a first time unit and a second image related to a second time unit which is shorter than the first time unit.

9. The display device according to claim 8, wherein
the first image and the second image are different in display form.

10. The display device according to claim 9, wherein
the first image is a number, and the second image is a pie chart.

11. The display device according to claim 1, further comprising:
an image acquisition unit configured to acquire the displayed image from an external device; and
a projection unit configured to project the display device and the information image.
